(19) United States
(12) Patent Application Publication
(10) Pub. No.: US 2023/0401618 A1
(43) Pub. Date: Dec. 14, 2023

(54) FENCING BROKERING ARRANGEMENT AND METHOD

(71) Applicant: Ceddy Pty Ltd, Swanbourne (AU)

(72) Inventor: Matthew Lloyd Sivewright, Swanbourne (AU)

(21) Appl. No.: 18/237,316

(22) Filed: Aug. 23, 2023

Related U.S. Application Data
(63) Continuation of application No. 17/897,423, filed on Aug. 29, 2022.
Application No. 17/897,423 is a continuation of application No. 17/115,041, filed on Dec. 8, 2020, now abandoned.
Application No. 17/115,041 is a continuation of application No. 16/312,945, filed on Dec. 21, 2018, now abandoned.

(30) Foreign Application Priority Data
Dec. 12, 2016 (AU) 2016905137

(51) Int. Cl. G06Q 30/0601; G06F 3/0482; G06F 3/04847; G06Q 30/0283; G06Q 50/08

(52) U.S. Cl. CPC G06Q 30/0611; G06F 3/0482; G06F 3/04847; G06Q 30/0283; G06Q 50/08; G01C 11/00

(57) ABSTRACT

Provided is a fencing brokering arrangement 300 comprising a satellite geographic demarcation computing system 312 and an administration computing system 304 arranged in signal communication via a communications network 202 facilitating transactions between the computing systems and a plurality of users. The administration computing system 304 is configured to operatively provide a GUI 312 to at least one user 318. The GUI is adapted to i) allow the user 318 to demarcate a specific geographic area 311 via the satellite geographic demarcation computing system 312, ii) provide a plurality of design modules with selectable fencing characteristics that, when selected by the user via the GUI, allow generation of a quote for fencing the demarcated geographic area 311, iii) automatically tender the quote to a plurality of fencing contractors 322, and iv) present acceptance and/or counteroffer(s) by the fencing contractors to the user via the GUI 312.

### CROSS-REFERENCE TO RELATED APPLICATIONS

This application is a continuation of application Ser. No. 17/897,423 filed Aug. 29, 2022, which is a continuation of application Ser. No. 17/115,041 filed Dec. 8, 2020, which is a continuation of application Ser. No. 16/312,945 filed Dec. 21, 2018, which is a national stage of PCT/AU2017/051279, filed Nov. 21, 2017, which claims the benefit of Application No. AU2016905137, filed Dec. 12, 2016 each of which is incorporated herein by reference in its entirety as if fully set forth herein.

### TECHNICAL FIELD

This invention relates to the field of online commerce, in general. More particularly, the invention provides for a fencing brokering arrangement and associated fencing brokering method, as well as an administration computing system for a fencing brokering arrangement and an associated computer programme product.

### BACKGROUND ART

The following discussion of the background art is intended to facilitate an understanding of the present invention only. The discussion is not an acknowledgement or admission that any of the material referred to is or was part of the common general knowledge as at the priority date of the application.

Applicant has identified a need in the art for a means whereby a user, whom is in need of fencing work, is able to easily obtain an accurate quote for such fencing work without requiring a contractor to perform a site visit to provide the quote, as well as to easily engage a contractor to perform such fencing work.

As such, the present invention seeks to propose possible solutions, at least in part, in amelioration of this need in the art.

### SUMMARY OF THE INVENTION

It is to be appreciated that reference to a ‘transaction’ herein generally refers to an electronic provision, transfer or exchange of digital information across an open and/or secured communications network, such as the Internet, or the like. Accordingly, where it is evident to the skilled addressee that any type of information or data is provided to, or received from, a party, such action is likely to constitute a transaction unless the context clearly indicates otherwise.

In addition, it is to be understood that reference herein to a ‘GUI’ refer to a graphical user interface, being a user interface that allows a user to interact with an electronic device or similar computing system through manipulation of graphical icons, visual indicators, text-based typed command labels and/or text navigation, including primary and/or secondary notations, as is known in the art of computer science.

According to a first aspect of the invention there is provided a fencing brokering arrangement comprising:
a satellite geographic demarcation computing system and an administration computing system arranged in signal communication via a communications network facilitating transactions between the computing systems and a plurality of users, wherein the administration computing system is configured to operatively provide a GUI to at least one user, the GUI adapted to:
i) allow the user to demarcate a specific geographic area via the satellite geographic demarcation computing system;
ii) provide a plurality of design modules with selectable fencing characteristics that, when selected by the user via the GUI, allow generation of a quote for fencing the demarcated geographic area;
iii) automatically tender the quote to a plurality of fencing contractors; and
iv) present acceptance and/or counteroffer(s) by the fencing contractors to the user via the GUI.

Typically, the design modules each comprises a database of different options for fencing specification customisation options selectable from a group consisting of fencing type, fencing size, fencing material, fencing decoration type, fencing decoration style, fencing manufacturing method, fencing colour, fencing installation type, and fencing installation method.

Typically, the GUI is configured to allow generation of the quote by including a pricing engine comprising a pricing algorithm adapted to provide fencing pricing information according to any of the selected fencing customisation specifications whenever the user selects and/or changes the fencing specifications.

Typically, the GUI is adapted to allow the user to demarcate a specific geographic area via the satellite geographic demarcation computing system by a suitable processor of the administration computing system executing a particular application programming interface (API) routine.

Typically, the satellite geographic demarcation computing system comprises a geographic information system (GIS) for displaying data related to positions on the Earth's surface.

Typically, the administration computing system is adapted to facilitate fund transfers from the user to a fencing contractor, i.e. include a payment facility, act as intermediary, etc.

In one example, the fencing characteristics include location details, such as surface incline, surface material, and the like.

Typically, the administration computing system is configured to register a user profile via the GUI.

Similarly, in one example the administration computing system is configured to register a fencing contractor profile, said profile including an indication from the contractor around costings on providing the selectable fencing characteristics.

According to a second aspect of the invention there is provided a fencing brokering method comprising the steps of:
via an administration computing system, providing a GUI to at least one user on a communications network, the GUI adapted to allow the user to demarcate a specific geographic area via a satellite geographic demarcation computing system on the network, the administration computing system including a plurality of selectable fencing characteristics that, when selected by the user, allow generation of a quote for fencing the demarcated geographic area;
receiving a selection of fencing characteristics via the GUI from the user;
tendering the quote to a plurality of fencing contractors; and
via the GUI, presenting acceptance and/or counteroffer(s) by the fencing contractors to the user.

Typically, the GUI is adapted to allow the user to demarcate a specific geographic area via the satellite geographic demarcation computing system by the administration computing system executing a particular application programming interface (API) routine.

Typically, the satellite geographic demarcation computing system comprises a geographic information system (GIS) for displaying data related to positions on the Earth's surface.

Typically, the method may include a further step of the administration computing system facilitating a fund transfer from the user and to a fencing contractor, i.e. a payment facility.

Typically, the fencing characteristics are selected from a non-exhaustive group consisting of a fence type, a fence material, a fence colour, a fence style and fencing decoration.

In one example, the fencing characteristics include location details, such as surface incline, surface material, and the like.

Typically, the method includes a step of, by the administration computing system, registering a user profile via the GUI.

Similarly, in one example the method includes a step of, by the administration computing system, registering a fencing contractor profile.

According to a third aspect of the invention there is provided an administration computing system for a fencing brokering arrangement, said administration computing system comprising:
(1) an input/output interface configured to receive and transmit transaction data via a communications network;
(2) a non-transitory electronic storage device configured to house a database for storing processor instructions; and
(3) a processor operatively arranged in signal communication with the input/output interface and the storage device, said processor adapted to:
provide a GUI to at least one user on the communications network, the GUI adapted to allow the user to demarcate a specific geographic area via a satellite geographic demarcation computing system on the network, the database including a plurality of selectable fencing characteristics that, when selected by the user via the GUI, allow generation of a quote for fencing the demarcated geographic area;
receive a selection of fencing characteristics via the GUI from the user;
tender the quote to a plurality of fencing contractors; and
via the GUI, present acceptance and/or counteroffer(s) by the fencing contractors to the user.

Typically, the GUI is adapted to allow the user to demarcate a specific geographic area via the satellite geographic demarcation computing system by the processor executing a particular application programming interface (API) routine.

Typically, the GUI includes design modules each comprising a database of different options for fencing specification customisation options selectable from a group consisting of fencing type, fencing size, fencing material, fencing decoration type, fencing decoration style, fencing manufacturing method, fencing colour, fencing installation type, and fencing installation method.

Typically, the GUI is configured to allow generation of the quote by including a pricing engine comprising a pricing algorithm adapted to provide fencing pricing information according to any of the selected fencing customisation specifications whenever the user selects and/or changes the fencing specifications.

Typically, the satellite geographic demarcation computing system comprises a geographic information system (GIS) for displaying data related to positions on the Earth's surface.

Typically, the processor is adapted to facilitate fund transfers from the user and to a fencing contractor, i.e. include a payment facility.

In one example, the fencing characteristics include location details, such as surface incline, surface material, and the like.

Typically, the processor is configured to register a user profile via the GUI.

In one example, the processor is configured to register a fencing contractor profile.

According to a further aspect of the invention there is provided a computer programme product which, when executed by a suitable computing system, facilitates the performance of the method steps in accordance with the second aspect of the invention above.

According to a yet further aspect of the invention there is provided a computer programme product which, when executed by a suitable administration computing system, facilitates the performance of the processor steps in accordance with the third aspect of the invention above.

### BRIEF DESCRIPTION OF THE DRAWINGS

The description will be made with reference to the accompanying drawings in which:

FIG. 1 illustrates a functional block diagram of an example processing or computing system that can be utilised to embody or give effect to a particular embodiment of the various computing systems described herein;

FIG. 2 illustrates an example network infrastructure that can be utilised to embody or give effect to a particular embodiment of a communications network whereby transactions between computing systems can be performed;

FIG. 3 is a diagrammatic flow diagram of one example of a fencing brokering arrangement, including a representation of method steps for performing one mode of a fencing brokering method, in accordance with various aspects of the current invention; and

FIG. 4 is a diagrammatic representation of one example of a fencing brokering arrangement, in accordance with an aspect of the present invention.

### DETAILED DESCRIPTION OF EMBODIMENTS

Further features of the present invention are more fully described in the following description of several non-limiting embodiments thereof. This description is included solely for the purposes of exemplifying the present invention to the skilled addressee. It should not be understood as a restriction on the broad summary, disclosure or description of the invention as set out above. In the figures, incorporated to illustrate features of the example embodiment or embodiments, like reference numerals are used to identify like parts throughout.

The current disclosure provides for a fencing brokering arrangement 300 comprising a number of computing or processing systems, as well as associated fencing brokering methods. As it is specifically envisaged that the various examples of the methods described herein will be computer-implemented methods, general examples of a processing or computing system 100 and a communications network 200 are provided first, that can be used to implement the various computing systems and the overall arrangement 300, as will be understood by the skilled addressee.

It is also to be appreciated that any reference herein to “means” specifically includes any one or more of a computer program product for use in a local or dispersed computing system, a computer readable modulated carrier signal for interpretation by a local or dispersed computing system, or a computer readable medium of instructions for enabling a local or dispersed computing system to provide such “means” within the context of the description. In addition, such “means” may further expressly comprise any of the hardware and/or software components, independently or in combination, provided for in the description below, performing a particular function as will be understood by the skilled addressee.

In general, in a networked information or data communications system, a user has access to one or more terminals which are capable of requesting and/or receiving information or data from local or remote information sources. In such a communications system, a terminal may be a type of processing system, computer or computerised device, personal computer (PC), mobile, cellular or satellite telephone, mobile data terminal, portable computer, Personal Digital Assistant (PDA), pager, thin client, or any other similar type of digital electronic device.

The capability of such a terminal to request and/or receive information or data can be provided by software, hardware and/or firmware. A terminal may include or be associated with other devices, for example a local data storage device such as a hard disk drive or solid state drive.

An information source can include a server, or any type of terminal, that may be associated with one or more storage devices that are able to store information or data, for example in one or more databases residing on a storage device. The exchange of information (i.e., the request and/or receipt of information or data) between a terminal and an information source, or other terminal(s), is facilitated by a communication means. The communication means can be realised by physical cables, for example a metallic cable such as a telephone line, semi-conducting cables, electromagnetic signals, for example radio-frequency signals or infra-red signals, optical fibre cables, satellite links or any other such medium or combination thereof connected to a network infrastructure.

The network infrastructure can include devices such as a telephone switch, base station, bridge, router, or any other such specialised network component, which facilitates the connection between a terminal and an information source. Collectively, an interconnected group of terminals, communication means, infrastructure and information sources is referred to as a network.

The network itself may take a variety of forms. For example, it may be a computer network, telecommunications network, data communications network, Local Area Network (LAN), Wide Area Network (WAN), wireless network, Internetwork, Intranetwork, the Internet and developments thereof, transient or temporary networks, combinations of the above or any other type of network providing for communication between computerised, electronic or digital devices.

More than one distinct network can be provided, for example a private and a public network. A network as referenced in this specification should be taken to include any type of terminal or other similar type of electronic device, or part thereof, which is rendered such that it is capable of communicating or transacting with at least one other terminal.

One example of facilitating communication across such networks is the Hyper-Text Mark-Up Language (HTML) and Hyper-Text Transfer Protocol (HTTP), and developments thereof, which have made the Internet or World Wide Web (WWW) very accessible. The exchange of information on the Internet is further facilitated through hyper-text documents. Hyper-Text documents are unique in that they use tags to define links which, when selected, retrieve the related information from within the same document or from a new document altogether.

The links are defined using HTML which provides a document formatting method which adapts in a consistent manner to any computer on which it is displayed. HTML tags are used to define various components of text, visual or audio which make up a hyper-text document, including such things as formatting and linking to other documents. HTML tags which link documents on one Internet information source to those on another do so by associating a Uniform Resource Locator (URL) with the referenced information.

One appeal of the Internet is the large-scale interconnection of public and private networks. A proxy is a host computer or mechanism (usually an application program) on a network node or terminal which performs specialised functions on a network. One such function is to provide network security. Security is provided between a private and public network by requiring communications (i.e. information or data exchanges) to pass through the proxy.

Another function of a proxy is to store or cache recently accessed information, for example copies of documents and images. If a web browser desires information which is located outside the local network, that is to say on an information source attached to an external network, communications pass from the web browser through the proxy before entering the external network. Thus, a proxy may operate to deny access to a private network from a public network by not replying to HTTP commands received from the public network.

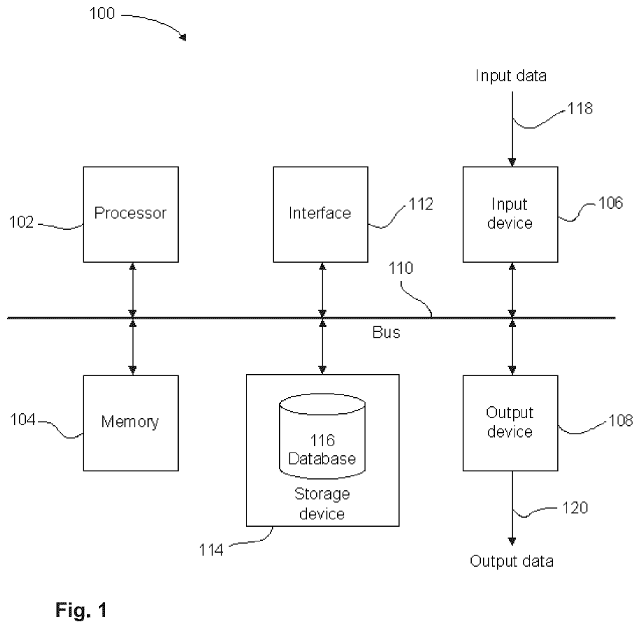

Embodiments of the present invention can be realised using a computing or processing system 100, an example of which is shown in FIG. 1. In particular, the processing system 100 generally includes at least one processor 102, or processing unit or plurality of processors, memory 104, at least one input device 106 and at least one output device 108, coupled together via a bus or group of buses 110.

In certain embodiments, input device 106 and output device 108 could be the same device, e.g. a touchscreen. An interface 112 can also be provided for coupling the processing system 100 to one or more peripheral devices, for example interface 112 could be a PCI card or PC card. At least one storage device 114 which houses at least one database 116 can also be provided. The memory 104 can be any form of memory device, for example, volatile or non-volatile memory, solid state storage devices, magnetic devices, etc. The processor 102 could include more than one distinct processing device, for example to handle different functions within the processing system 100.

Input device 106 receives input data 118 and can include, for example, a keyboard, a pointer device such as a pen-like device or a mouse, audio receiving device for voice controlled activation such as a microphone, data receiver or antenna such as a modem or wireless data adaptor, data acquisition card, a touchscreen for receiving tactile input, etc. Input data 118 could come from different sources, for example keyboard instructions in conjunction with data received via a network.

Output device 108 produces or generates output data 120 and can include, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network.

A user could view data output, or an interpretation of the data output, on, for example, a monitor or using a printer. The storage device 114 can be any form of data or information storage means, for example, volatile or non-volatile memory, solid state storage devices, magnetic devices, etc.

In use, the processing system 100 is adapted to allow data or information to be stored in and/or retrieved from, via wired or wireless communication means, the at least one database 116. The interface 112 may allow wired and/or wireless communication between the processing unit 102 and peripheral components that may serve a specialised purpose. The processor 102 receives instructions as input data 118 via input device 106 and can display processed results or other output to a user by utilising output device 108. More than one input device 106 and/or output device 108 can be provided. It should be appreciated that the processing system 100 may be any form of terminal, server, specialised hardware, or the like.

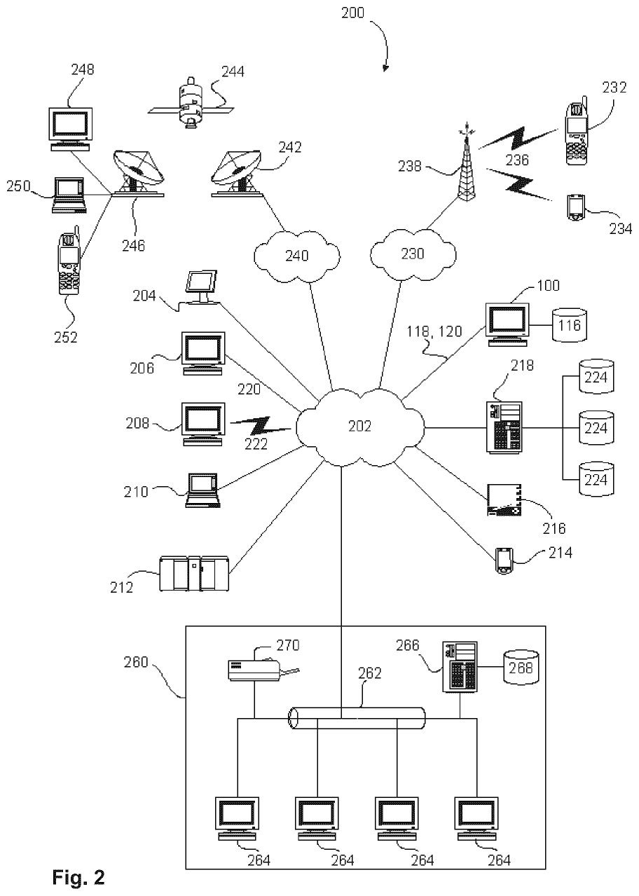

In addition, the processing system 100 is generally part of a networked communications system 200, as shown in FIG. 2. Processing system 100 could connect to network 202, for example the Internet or a WAN. Input data 118 and output data 120 could be communicated to other devices via network 202. Other terminals, for example, thin client 204, further processing systems 206 and 208, notebook computer 210, mainframe computer 212, PDA 214, pen-based computer 216, server 218, etc., can be connected to network 202. A large variety of other types of terminals or configurations could be utilised.

The transfer of information and/or data over network 202 can be achieved using wired communications means 220 or wireless communications means 222. Server 218 can facilitate the transfer of data between network 202 and one or more databases 224.

Other networks may communicate with network 202. For example, telecommunications network 230 could facilitate the transfer of data between network 202 and mobile or cellular telephone 232 or a PDA-type device 234, by utilising wireless communication means 236 and receiving/transmitting station 238. Satellite communications network 240 could communicate with satellite signal receiver 242 which receives data signals from satellite 244 which in turn is in remote communication with satellite signal transmitter 246.

Terminals, for example further processing system 248, notebook computer 250 or satellite telephone 252, can thereby communicate with network 202. A local network 260, which for example may be a private network, LAN, etc., may also be connected to network 202. For example, network 202 could be connected with Ethernet 262 which connects terminals 264, server 266 which controls the transfer of data to and/or from database 268, and printer 270. Various other types of networks could be utilised.

The processing system 100 is adapted to communicate with other terminals, for example further processing systems 206, 208, by sending and receiving data, 118, 120, to and from the network 202, thereby facilitating possible communication with other components of the networked communications system 200.

Thus, for example, the networks 202, 230, 240 may form part of, or be connected to, the Internet, in which case, the terminals 206, 212, 218, for example, may be web servers, Internet terminals or the like. The networks 202, 230, 240, 260 may be or form part of other communication networks, such as LAN, WAN, Ethernet, token ring, FDDI ring, star, etc., networks, or mobile telephone networks, such as GSM, CDMA or 3G, etc., networks, and may be wholly or partially wired, including for example optical fibre, or wireless networks, depending on a particular implementation.

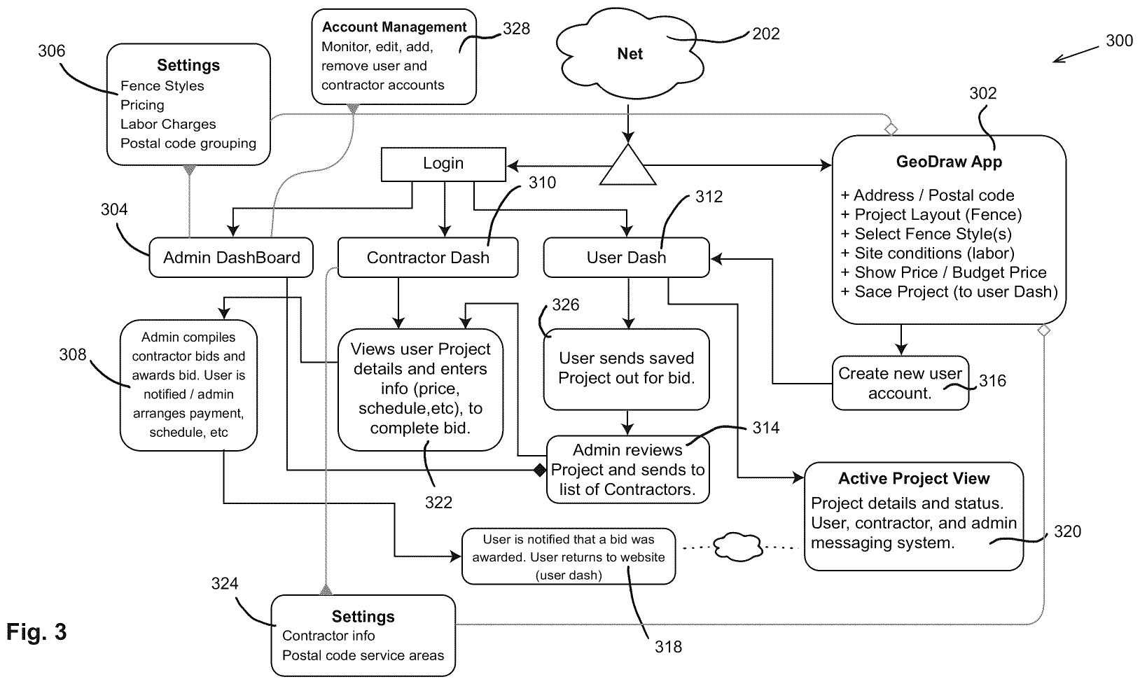

Accordingly, in light of the above description, one example of the fencing brokering arrangement 300, as shown in FIG. 3, generally comprises an administration computing system, as represented by function steps 304, 306, 308, 314 and 328. The arrangement 300 also includes a satellite geographic demarcation computing system, as represented by function step 302, as well as a communications network 202, as described above. In use, the network 202 arranges the administration and demarcation computing systems 302 and 304 in signal communication with each other, with the network 202 facilitating communications or transactions between the computing systems and a plurality of users or terminals, as described above, and represented by user dash 312 and contractor dash 310.

The administration computing system 304 is generally configured to operatively provide a GUI, such as the user dash 312, to at least one user, with the GUI adapted to allow the user to demarcate a specific geographic area via the satellite geographic demarcation computing system 302.

As will be understood by the skilled addressee, the administration computing system 304 is generally configured to register a user profile via the GUI, e.g. provide the user dash 312 via which a user account or profile can be registered, as represented by function block 316.

Similarly, the administration computing system 304 is generally configured to register a fencing contractor profile, e.g. provide contractor dash 310 for capturing a contractor profile with settings 324 and whereby a contractor can view tendered fencing projects 322, as described below, etc.

The satellite geographic demarcation computing system 302 typically comprises a geographic information system (GIS) for displaying data related to positions on the Earth's surface. For example, GeoDraw™ or Google Maps™ are examples of such a GIS system whereby a user is able to demarcate a particular geographic area.

It is to be appreciated that the GUI is typically adapted to allow the user to demarcate a specific geographic area via the satellite geographic demarcation computing system 302 by a suitable processor of the administration computing system executing a particular application programming interface (API) routine.

To this end, The GUI generally provide a plurality of design modules with selectable fencing characteristics that, when selected by the user via the GUI, allow generation of a quote for fencing the demarcated geographic area. Typically, the design modules each comprises a database of different options for fencing specification customisation options selectable from a group consisting of fencing type, fencing size, fencing material, fencing decoration type, fencing decoration style, fencing manufacturing method, fencing colour, fencing installation type, and fencing installation method.

The GUI is further typically configured to allow generation of the quote by including a pricing engine comprising a pricing algorithm adapted to provide fencing pricing information according to any of the selected fencing customisation specifications whenever the user selects and/or changes the fencing specifications.

The administration computing system 304 also generally includes a plurality of selectable fencing characteristics 306 that, when selected by the user, allow generation of a quote 308 for fencing the demarcated geographic area. These fencing characteristics 306 can include fence type, fence material, fence colour, fence style, fencing decoration, and/or any aspects relevant to the required fencing. The fencing characteristics 306 can also include location specific details, such as surface incline, a surface material, i.e. soil, rock, etc. The skilled addressee will appreciate that the fencing characteristics 306 can include any characteristics that may influence or determine the quote. Once the user has specified all requirements, it is submitted for quote generation via the GUI 326.

Accordingly, by a user selecting the desired characteristics 306, the administration computing system 304 is able to tender the generated quote 314 to a plurality of fencing contractors and to present acceptance and/or counteroffer(s) by the fencing contractors to the user via the GUI 318. In a preferred embodiment, the administration computing system 304 is also adapted to facilitate fund transfers from the user and to a fencing contractor, i.e. include a payment facility 308. The skilled addressee will appreciate that various fund transfer arrangements are apposite, e.g. direct payment between user and contractor, the administration computing system 304 may act as intermediary, or the like. In this example, the administration computing system 304 also includes account management functionality 328 whereby user and/or contractor accounts can be managed.

The present invention further provides for an associated fencing brokering method generally performed by the arrangement 300. Such a method generally comprises the steps of, via an administration computing system 304, providing a GUI 312 to at least one user on the communications network 202, the GUI adapted to allow the user to demarcate a specific geographic area via a satellite geographic demarcation computing system 312 on the network 202.

As described, the administration computing system 304 typically includes a plurality of selectable fencing characteristics that, when selected by the user, allow generation of a quote for fencing the demarcated geographic area.

The method further includes the steps of receiving a selection of fencing characteristics via the GUI from the user, and tendering the quote 314 to a plurality of fencing contractors 322, as well as via the GUI 320, presenting acceptance and/or counteroffer(s) by the fencing contractors to the user 318.

In accordance with the general examples of a computing system 100 above, it is to be appreciated that the invention provides for the administration computing system 304 of the fencing brokering arrangement 300. As such, one example of the administration computing system 304 comprises an input/output interface 106, 108 configured to receive and transmit transaction data 118, 120 via the communications network 202.

The administration computing system 304 also typically includes a non-transitory electronic storage device 114 configured to house a database 116 for storing processor instructions, along with a processor 102 operatively arranged in signal communication with the input/output interface and the storage device.

The processor 102 is typically adapted to provide the GUI to at least one user on the communications network 202, with the GUI adapted to allow the user to demarcate a specific geographic area via the satellite geographic demarcation computing system 302 on the network 202. As described, the database 116 includes a plurality of selectable fencing characteristics that, when selected by the user via the GUI, allow generation of a quote for fencing the demarcated geographic area.

The processor 102 is further adapted to receive the selection of fencing characteristics via the GUI from the user, and to subsequently tender the quote to a plurality of fencing contractors. Once the contractors have bid for the quote 322, the processor 102 presents acceptance and/or counteroffer(s) by the fencing contractors to the user via the GUI, as described.

It is further to be appreciated that the present invention also provides for associated computer programme product which, when executed by a suitable computing system, facilitates the performance of the method steps described above.

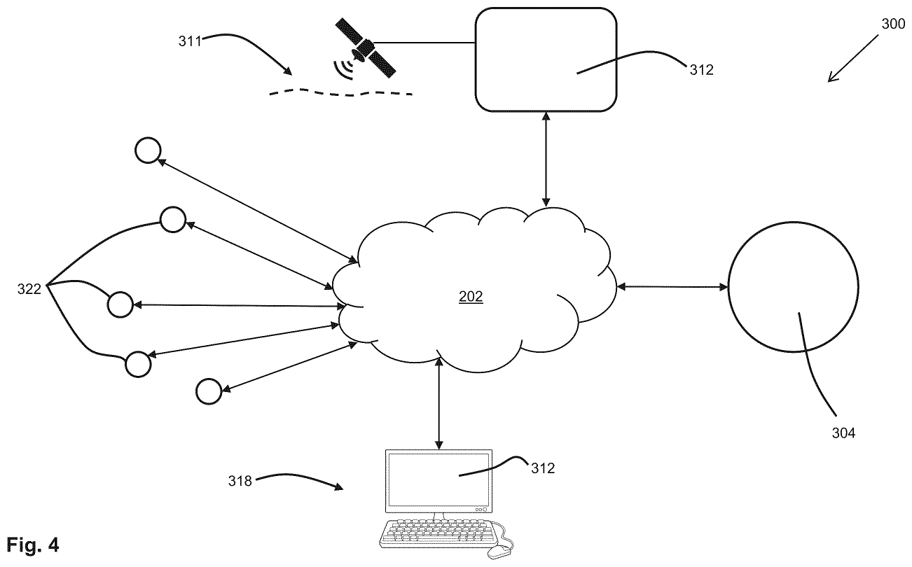

FIG. 4 shows a diagrammatic representation of one example of the fencing brokering arrangement 300, as described above. In this example, the fencing brokering arrangement 300 comprises the satellite geographic demarcation computing system 312 and the administration computing system 304 arranged in signal communication via the communications network 202. As described above, the network 202 facilitates transactions between the computing systems and a plurality of users. The administration computing system 304 is configured to operatively provide a GUI 312 to at least one user (using computing system 318, for example).

The GUI 312 is adapted to allow the user 318 to demarcate a specific geographic area 311 via the satellite geographic demarcation computing system 312, and to provide a plurality of design modules with selectable fencing characteristics that, when selected by the user via the GUI 312, allow generation of a quote for fencing the demarcated geographic area. The GUI is also configured to automatically tender the quote to a plurality of fencing contractors 322 and to present acceptance of the quote and/or counteroffer(s) to the quote by the fencing contractors 322 to the user 318 via the GUI 312.

The Applicant believes it advantageous that the inventions described herein allow for an elegant and efficient way for a user to obtain an accurate quote for fencing work without requiring a contractor to perform a site visit to provide the quote. In addition, the present invention provides a means for easily engaging a contractor to perform fencing work.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth. In the example embodiments, well-known processes, well-known device structures, and well known technologies are not described in detail, as such will be readily understood by the skilled addressee.

The use of the terms “a”, “an”, “said”, “the”, and/or similar referents in the context of describing various embodiments (especially in the context of the claimed subject matter) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. As used herein, the term “and/or” includes any and all combinations of one or more of the associated listed items. No language in the specification should be construed as indicating any non-claimed subject matter as essential to the practice of the claimed subject matter.

It is to be appreciated that reference to “one example” or “an example” of the invention, or similar exemplary language (e.g., “such as”) herein, is not made in an exclusive sense. Various substantially and specifically practical and useful exemplary embodiments of the claimed subject matter are described herein, textually and/or graphically, for carrying out the claimed subject matter.

Accordingly, one example may exemplify certain aspects of the invention, whilst other aspects are exemplified in a different example. These examples are intended to assist the skilled person in performing the invention and are not intended to limit the overall scope of the invention in any way unless the context clearly indicates otherwise. Variations (e.g. modifications and/or enhancements) of one or more embodiments described herein might become apparent to those of ordinary skill in the art upon reading this application.

Any method steps, processes, and operations described herein are not to be construed as necessarily requiring their performance in the particular order discussed or illustrated, unless specifically identified as an order of performance. It is also to be understood that additional or alternative steps may be employed.

1. A fencing brokering system for online brokering of fencing installations without requiring a contractor to perform a site visit, said fencing brokering system comprising:
a satellite geographic demarcation computing system whereby a user is able virtually to demarcate a specific geographic area;
at least one remote user terminal;
a plurality of remote fencing contractor terminals; and
an administration computing system coupled via a network to the satellite geographic demarcation system, user and contractor terminals, said administration computing system configured to provide a GUI to the user terminal for demarcating an area and having a pricing engine, a plurality of design modules with selectable fencing characteristics and fencing contractor profiles indicating costings on labour and such fencing characteristics, the fencing characteristics including geographic area details of the demarcated area, including a surface incline and a surface material, so that when a user demarcates and selects desired fencing characteristics from said design modules, the pricing engine automatically generates a quote for fencing the demarcated geographic area.

2. The arrangement of claim 1, wherein the design modules each comprises a database of different options for the fencing characteristics selectable from a group consisting of fencing type, fencing size, fencing material, fencing decoration type, fencing decoration style, fencing manufacturing method, fencing colour, fencing installation type, and fencing installation method.

3. The arrangement of claim 1, wherein the administration computing system is configured to automatically tender the quote to the plurality of fencing contractor terminals and present acceptance and/or counteroffer(s) by such fencing contractors to the user via the GUI.

4. The arrangement of claim 3, wherein the pricing engine comprises a pricing algorithm adapted to provide fencing pricing information according to the geographic area details of the demarcated geographic area and any of the selected fencing characteristics whenever the user selects and/or changes such fencing characteristics.

4. The arrangement of claim 4, wherein the satellite geographic demarcation computing system comprises a geographic information system (GIS) for displaying data related to positions on the Earth's surface and providing geographic area details of the demarcated geographic area.

5. The arrangement of claim 1, wherein the administration computing system is adapted to facilitate online fund transfers from the user to a fencing contractor.

6. A fencing brokering method comprising the steps of:
via an administration computing system, providing a GUI to at least one user on a communications network, the GUI adapted to allow the user to demarcate a specific geographic area via a satellite geographic demarcation computing system on the network, the administration computing system including a plurality of selectable fencing characteristics that, when selected by the user, allow generation of a quote for fencing the demarcated geographic area, the fencing characteristics comprising geographic area details of the demarcated geographic area, including a surface incline and a surface material, said administration computing system configured to register a fencing contractor profile which includes an indication from the contractor around costings on providing the selectable fencing characteristics with associated labour costs to facilitate in generation of said quote;
receiving a selection of fencing characteristics via the GUI from the user;
tendering the quote to a plurality of fencing contractors; and
via the GUI, presenting acceptance and/or counteroffer(s) by the fencing contractors to the user.

7. The method of claim 6, wherein the fencing characteristics are selected from a non-exhaustive group consisting of a fencing type, fencing size, fencing material, fencing decoration type, fencing decoration style, fencing manufacturing method, fencing colour, fencing installation type, and fencing installation method.

9. The method of claim 6, wherein the GUI is adapted to allow the user to demarcate a specific geographic area via the satellite geographic demarcation computing system by the administration computing system executing a particular application programming interface (API) routine.

10. The method of claim 6, wherein the satellite geographic demarcation computing system comprises a geographic information system (GIS) for displaying data related to positions on the Earth's surface.

11. The method of claim 6, which includes a further step of the administration computing system facilitating an online fund transfer from the user to a fencing contractor.
